(19) United States
(12) Patent Application Publication
(10) Pub. No.: US 2020/0072379 A1
(43) Pub. Date: Mar. 5, 2020

(54) Faucet Extension Tool

(71) Applicant: Gordon Grimm, Edgewood, WA (US)

(72) Inventor: Gordon Grimm, Edgewood, WA (US)

(21) Appl. No.: 16/122,299

(22) Filed: Sep. 5, 2018

(51) Int. Cl. F16K 31/46; E03C 1/04; F16K 31/60

(52) U.S. Cl. CPC F16K 31/46; F16K 31/60; E03C 1/04

(57) ABSTRACT

A faucet extension tool for reaching and operating a faucet handle includes a tool handle having a butt end and an attachment end. An extension rod has a proximal end and a distal end with the proximal end coupled to the attachment end of the tool handle. A faucet engagement head has a neck and a pair of arms with the neck coupled to the distal end of the extension rod. The pair of arms is coupled to the neck and is configured to engage a faucet handle.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

(1) Field of the Invention

(2) Description of Related Art Including Information Disclosed Under 37 CFR 1.97 and 1.98.

The disclosure and prior art relates to extension tools and more particularly pertains to a new extension tool for reaching and operating a faucet handle.

### (h) BRIEF SUMMARY OF THE INVENTION

An embodiment of the disclosure meets the needs presented above by generally comprising a tool handle having a butt end and an attachment end. An extension rod has a proximal end and a distal end with the proximal end coupled to the attachment end of the tool handle. A faucet engagement head has a neck and a pair of arms with the neck coupled to the distal end of the extension rod. The pair of arms is coupled to the neck and is configured to engage a faucet handle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a faucet extension tool according to an embodiment of the disclosure.

FIG. 2 is a side elevation view of an embodiment of the disclosure.

FIG. 3 is a bottom plan view of an embodiment of the disclosure.

FIG. 4 is a front elevation view of an embodiment of the disclosure.

FIG. 5 is an in-use detail view of an embodiment of the disclosure.

### (j) DETAILED DESCRIPTION OF THE INVENTION

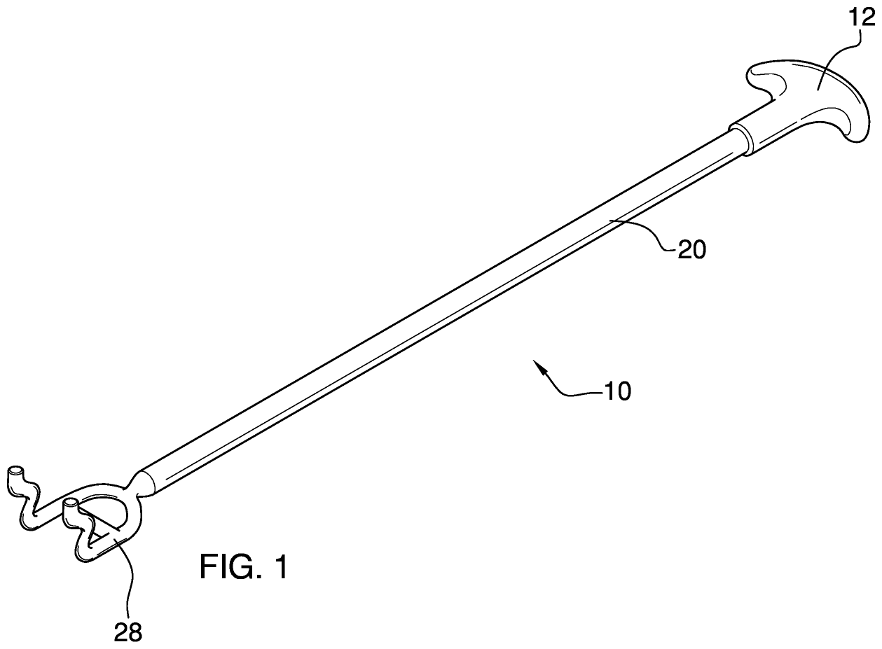

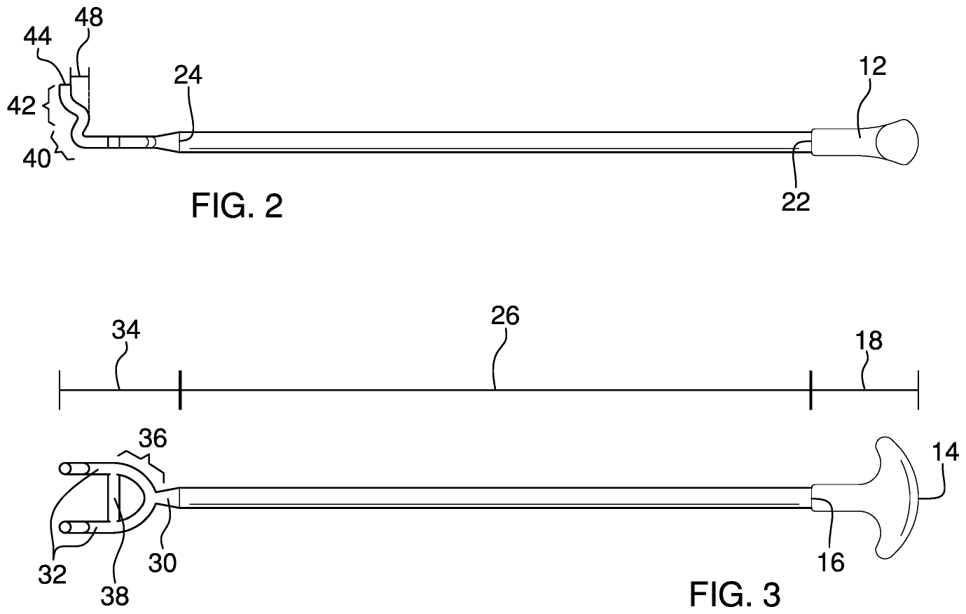

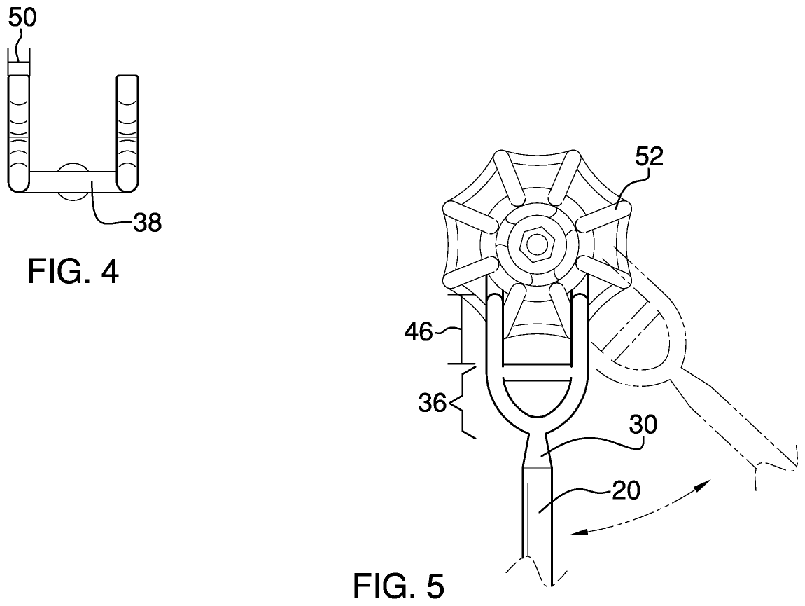

With reference now to the drawings, and in particular to FIGS. 1 through 5 thereof, a new extension tool embodying the principles and concepts of an embodiment of the disclosure and generally designated by the reference numeral 10 will be described.

As best illustrated in FIGS. 1 through 5, the faucet extension tool 10 generally comprises a tool handle 12 having a butt end 14 and an attachment end 16. The tool handle 12 may be a T-shape and the butt end 14 may be curved. The tool handle 12 may have a handle length 18 of approximately 5 cm. An extension rod 20 has a proximal end 22 coupled to the attachment end 16 of the tool handle and a distal end 24 and may have a rod length 26 of approximately 31 cm between the attachment proximal end 22 and the distal end 24. A faucet engagement head 28 is coupled to the extension rod 20 and has a neck 30 and a pair of arms 32. The faucet engagement head 28 may have a head length 34 of approximately 4.5 cm. The neck 30 is coupled to the distal end 24 of the extension rod and may be tapered. The pair of arms 32 has a U-shaped section 36 coupled to the neck 30 and may have a brace 38 coupled between each of the pair of arms 32 adjacent the U-shaped section 36 to improve structural integrity and to prevent the pair of arms 32 from being bent apart or together. Each of the pair of arms 32 may have a return section 40, an S-shaped section 42, and a tip 44. The return section 40 may have a return length 46 of approximately 1.9 cm from the brace 38. The S-shaped section 42 may have an amplitude 48 of approximately 0.79 cm extending above the tip 44. The pair of arms 32 may have a rod diameter 50 of approximately 0.48 cm. The pair of arms 32 is configured to engage a faucet handle 52.

In use, a user secures the faucet extension tool 10 by the tool handle 12 and engages the S-shaped section 42 and the return section 40 with the faucet handle 52. He or she may then manipulate the faucet handle 52 with from a distance to eliminate the need to bend over or access difficult to reach places and may turn the faucet handle more easily due to the increased leverage provided by the length of the extension rod.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A faucet extension tool comprising:
a tool handle, the tool handle having a butt end and an attachment end;
an extension rod coupled to the tool handle, the extension rod having a proximal end and a distal end, the proximal end being coupled to the attachment end of the tool handle; and
a faucet engagement head coupled to the extension rod, the faucet engagement head having a neck and a pair of arms, the neck being coupled to the distal end of the extension rod and the pair of arms being coupled to the neck, the pair of arms being configured to engage a faucet handle.

2. The faucet extension tool of claim 1 further comprising the tool handle being T-shaped.

3. The faucet extension tool of claim 1 further comprising the pair of arms having a U-shaped section and each of the pair of arms having a return section and an S-shaped section, the U-shaped section being adjacent the neck.

4. The faucet extension tool of claim 3 further comprising the pair of arms having a brace, the brace being coupled between each of the pair of arms adjacent the U-shaped section.

5. The faucet extension tool of claim 3 further comprising the neck being tapered.

6. The faucet extension tool of claim 2 further comprising the butt end of the T-shaped handle being curved.

7. A faucet extension tool comprising:
a tool handle, the tool handle having a butt end and an attachment end, the tool handle being a T-shape and the butt end being curved;
an extension rod coupled to the tool handle, the extension rod having a proximal end and a distal end, the proximal end being coupled to the attachment end of the tool handle; and
a faucet engagement head coupled to the extension rod, the faucet engagement head having a neck and a pair of arms, the neck being coupled to the distal end of the extension rod, the neck being tapered, the pair of arms having a U-shaped section coupled to the neck and a brace coupled between each of the pair of arms adjacent the U-shaped section, each of the pair of arms having a return section and an S-shaped section, the pair of arms being configured to engage a faucet handle.

7. A faucet handle and faucet extension tool combination comprising:
a faucet handle;
a tool handle, the tool handle having a butt end and an attachment end, the tool handle being a T-shape and the butt end being curved;
an extension rod coupled to the tool handle, the extension rod having a proximal end and a distal end, the proximal end being coupled to the attachment end of the tool handle; and
a faucet engagement head coupled to the extension rod, the faucet engagement head having a neck and a pair of arms, the neck being coupled to the distal end of the extension rod, the neck being tapered, the pair of arms having a U-shaped section coupled to the neck and a brace coupled between each of the pair of arms adjacent the U-shaped section, each of the pair of arms having a return section and an S-shaped section, the pair of arms engaging the faucet handle.
